(19) United States
(12) Patent Application Publication
(10) Pub. No.: US 2005/0098194 A1
(43) Pub. Date: May 12, 2005

(54) Semiconductor wafer immersion systems and treatments using modulated acoustic energy

(76) Inventors: Kurt K. Christenson, Minnetonka, MN (US); Thomas J. Wagener, Shorewood, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/939,067

(22) Filed: Sep. 10, 2004

Related U.S. Application Data
(60) Provisional application No. 60/501,956, filed on Sep. 11, 2003.

(51) Int. Cl. B08B 3/12; B08B 7/02; B08B 3/00

(52) U.S. Cl. 134/1; 134/1.3; 134/184; 134/902

(57) ABSTRACT

Systems and methods in which one or more wafers are immersed in a sonified liquid during the course of a treatment wherein the sound energy imparted to the liquid is modulated during at least a portion of a treatment. The frequency and/or amplitude of the sound energy may be modulated.

### PRIORITY CLAIM

The present non-provisional application claims priority under 35 USC §119(e) from United States Provisional Patent Application having Ser. No. 60/501,956, filed on Sep. 11, 2003, by Christenson et al. and titled FREQUENCY SWEEPING FOR ACOUSTIC FIELD UNIFORMITY, wherein said provisional application is commonly owned by the assignee of the present application and wherein the entire contents of said provisional application is incorporated herein by reference.

### FIELD OF THE INVENTION

The present invention relates to systems and methods for treating semiconductor wafers, and more particularly to systems and methods in which one or more wafers are immersed in a sonified bath during at least a portion of a treatment.

### BACKGROUND OF THE INVENTION

Acoustic energy, such as megasonic energy in the megahertz frequency range, is used in the microelectronics industry in the course of manufacturing microelectronic devices. In a representative system, a source of megasonic energy is coupled to a process chamber. Many semiconductor processing systems, for example, having megasonic capabilities are known. The source can be external to the process chamber or internal. Megasonic energy is often used in the course of cleaning and rinsing treatments. For instance, U.S. Pat. Nos. 4,869,278; 5,017,236; 5,365,960; and 6,367,493 describe processes that use megasonic energy. See also assignee's co-pending, United States Provisional Patent Application Ser. No. 60/501,969 titled “Acoustic Diffusers for Acoustic Field Uniformity,” filed concurrently herewith in the name of Christenson and having Attorney Docket No. FSI0121/P1, the disclosure of which is incorporated herein by reference in its entirety (hereinafter referred to as Assignee's Co-pending Provisional Application). See also assignee's co-pending United States Non-Provisional Patent Application titled “Acoustic Diffusers for Acoustic Field Uniformity,” filed concurrently herewith in the name of Christenson and having Attorney Docket No. FSI0121/US, the disclosure of which is incorporated herein by reference in its entirety (hereinafter referred to as Assignee's Co-pending Non-Provisional Application).

Megasonic energy and waves can be used for a variety of reasons, including cleaning and removing particles from the surface of semiconductor wafers during wafer processing into devices and integrated circuits. Megasonic energy generally refers to high frequency acoustic energy including frequencies in the range of from about 0.5 MHZ to about 2 MHZ or higher.

Megasonic cleaning is used at many stages in the fabrication process for removing particles, photoresist, dewaxing and degreasing using different solvents and stripping solutions. It has also been shown that megasonic energy can aid in the removal of particulates that are adhered to the wafer surface. The primary advantages of using megasonic cleaning is that it saves in the cost and wafer surface degradation of chemical cleaners, provides superior cleanliness and simultaneously cleans both sides of the wafers, thereby requiring less handling.

As the microelectronics industry moves to stricter standards and smaller device features, acoustic field uniformity in some applications becomes increasingly important. Smaller features tend to be more vulnerable to acoustic damage than some larger features. Accordingly, there is still a need in some applications to generate spatially and temporally uniform sound fields (minimized temporal variations) in a processing tank and especially to dampen the peak-to-peak height between field maxima and minima while still maintaining sufficient field strength to accomplish the desired treatment.

In other applications, cleaning performance becomes more critical inasmuch as particle contamination tends to be much less tolerable as device features become smaller. The ability to remove particles with greater and greater particle efficiency therefore is desired.

### SUMMARY OF THE INVENTION

The present invention involves systems and methods in which one or more wafers are immersed in a sonified liquid during the course of a treatment. According to the invention, the sound energy imparted to the liquid is modulated during at least a portion of a treatment. In many embodiments, and as described further below, the frequency and/or amplitude of the sound energy may be modulated to achieve one or more desired processing objectives. According to one objective, the sound energy is modulated in a manner to improve the spatial and/or temporal uniformity of the sound field established in the processing liquid. This can be accomplished in a variety of ways. Exemplary approaches include synchronizing the excitation of different sub-arrays of an acoustic energy source, exciting different sub-arrays or groups of sub-arrays in series or in partially overlapping fashion, using frequency sweeping techniques, or combinations of these.

In other modes of practice, the intensity of the sound energy field in a processing liquid is modulated for a variety of purposes such as to enhance particle removal efficiency and/or to allow at least a portion of a treatment to occur with more intense sound energy than might otherwise be practical without modulation.

In one aspect, the present invention relates to a method for processing one or more wafers in a sound field. One or more wafers are provided in a processing apparatus having a processing tank and a source of sound energy acoustically coupled to the processing tank. A sound field is established in the processing tank by inputting a non-constant driving signal to the source of sound energy.

In another aspect, the present invention relates to a method of driving a sound energy source. Information indicative of a resonant characteristic of a sound energy source is determined. Data comprising said information indicative of a resonant characteristic of a sound energy source is used to provide a non-constant driving signal as an input to modulate sound energy of the source.

In another aspect, the present invention relates to a method of modulating a sound field. Information indicative of a nonuniformity characteristic of a sound field is generated in a process fluid is determined. Data comprising said information indicative of a nonuniformity characteristic of a sound field generated in a process fluid is used to modulate the sound field.

In another aspect, the present invention relates to a method for processing one or more wafers in a sound field. One or more wafers that are immersed in a processing liquid are provided, wherein the processing liquid is acoustically coupled to a source of sound energy. A sound field is provided in the processing tank by inputting a non-constant driving signal to the source of sound energy, wherein the non-constant driving signal causes the source of sound energy to output sound energy whose intensity varies between one or more sound intensity maxima and one or more sound intensity minima.

In another aspect, the present invention relates to a method for processing one or more wafers in a sound field. One or more wafers are provided that are immersed in a processing liquid, wherein the processing liquid is acoustically coupled to a source of sound energy. An acoustic output of the source of sound energy is caused to vary between one or more sound intensity maxima and one or more sound intensity minima during at least a portion of carrying out a treatment of the one or more wafers.

In another aspect, the present invention relates to a method for processing one or more wafers in a sound field. One or more wafers are provided that are immersed in a processing liquid, wherein the processing liquid is acoustically coupled to a source of sound energy. The source of sound energy is caused to output sound energy at a duty cycle less than 100% during at least a portion of carrying out a treatment of the one or more wafers.

In another aspect, the present invention relates to a method for processing one or more wafers in a sound field. One or more wafers are provided that are immersed in a processing liquid, wherein the processing liquid is acoustically coupled to a source of sound energy. The source of sound energy is caused to pulse on and off during at least a portion of carrying out a treatment of the one or more wafers.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a schematic side view shown in cross section of an exemplary immersion processing tank useful for practicing embodiments of the present invention;

FIG. 2 is a schematic representation of the megasonic energy source used in the tank of FIG. 1;

FIG. 3 is a schematic representation of an alternative megasonic energy source that could be used in the tank of FIG. 1;

FIG. 4 schematically shows how the intensity of the sound field established inside the tank of FIG. 1 can vary when the megasonic energy source is operated conventionally;

FIG. 5 schematically shows a saw tooth frequency profile useful in practicing frequency sweeping in accordance with the present invention;

FIG. 6 schematically shows an alternative frequency profile useful in practicing frequency sweeping in accordance with the present invention;

FIG. 7 schematically shows one manner in which sub-arrays may be excited in groups to practice embodiments of the present invention;

FIG. 8 schematically shows another manner in which sub-arrays may be excited in groups to practice embodiments of the present invention;

FIG. 9 schematically shows a duty cycle profile by which a megasonic energy source may be modulated between sound field maxima and minima in accordance with the present invention;

FIG. 10 is a schematic side view shown in cross section of an exemplary immersion processing tank useful for practicing embodiments of the present invention in which the megasonic energy source is modulated between sound field maxima and minima in accordance with the present invention;

FIG. 11 is a bar graph showing particle removal efficiencies obtained at various combinations of duty cycle and repetition rate characteristics; and

FIG. 12 is a bar graph showing particle removal efficiencies obtained at various combinations of duty cycle and repetition rate characteristics.

### DETAILED DESCRIPTION OF THE PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

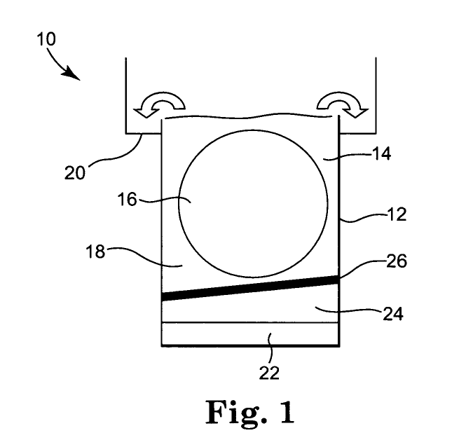

The principles of the present invention may be practiced in any kind of equipment in which one or more wafers are immersed in a sonified bath during the course of a treatment. One suitable and representative processing tank 10 with megasonic capabilities of the type used in a wet bench tool (such as the MAGELLAN tool® commercially available from FSI International, Inc., Chaska, Minn.) is shown schematically in cross-section in FIG. 1. Tank 10 may be used to treat wafers either singly or in batches. For higher throughput, batch processing is preferred. Tank 10 generally includes a housing 12 defining a process chamber 14 in which one or more wafers 16 are immersed in a cascading flow of process liquid 18. Liquid 18 may be introduced into process chamber 14 through one or more entry ports (not shown) located generally toward the bottom of process chamber 14. Liquid 18 exits process chamber 14 by cascadingly overflowing into overflow weir 20 generally at the top of process chamber 14.

Acoustic energy source 22 provides sound energy to the processing liquid 18. In this example, the acoustic energy source 22 is external to the process chamber 14. In typical embodiments, the acoustic energy source 22 incorporates a resonant structure (not shown) that generally comprises (from bottom to top) piezoelectric crystals bonded to a metal or ceramic support plate or the like. The acoustic energy source 22 is acoustically coupled to the contents inside the processing chamber 14 by a coupling fluid 24 such as water or the like. A quartz window 26 provides a pathway for acoustic energy to pass from the coupling fluid 24 into the process chamber 14.

The coupling fluid 24 is used to isolate the acoustic energy source 22 from the processing liquid 18 for a number of possible reasons such as (a) to prevent attack on the acoustic energy source 22 by the process liquid 18; (b) to prevent contamination of the processing liquid 18 by the acoustic energy source 22; and/or (c) to maintain a temperature differential between the coupling water 24 and the process liquid 18. The temperature of the coupling liquid 24 can be reduced to limit the temperature of the acoustic energy source 22.

Ideally, the quartz window 26 would be parallel to the transducer (not shown) of acoustic energy source 22 and spaced such that the standing waves in the coupling liquid 24 enhance transmission into the processing liquid 18. Achieving this would require holding dimensional tolerances to a fraction of the wavelength of the acoustic energy, e.g., a fraction of the 1.5 mm wavelength of 971 kHz (megasonic energy in DI). This can be difficult to achieve practically. In reality, the quartz window 26 is often deliberately tilted to create a rapid oscillation in the transmission pattern that hopefully “smoothes out” by the time the sound reaches the wafer(s) 16. This smoothening is unlikely to occur with the small plate-to-wafer spacing on certain tanks. As an optional component, an acoustic lens of the type described in Assignee's Co-pending Acoustic Lens Application may be interposed between the wafer(s) 16 and the acoustic energy source 22 to help provide more uniform sonification of process liquid 18.

The megasonic energy source 22 typically includes a plurality of piezoelectric crystals bonded in an array to a metal plate or other suitable support. The crystals may be driven by one or more power supplies, whose driving frequencies may or may not be coordinated. When more than one power supply is used, each power supply typically will drive sub-arrays of the crystals. For example, systems including two and four sub-arrays of crystals bonded to a support are commercially available and can be used for processing any desired wafers, including 200 mm and 300 mm wafers for example.

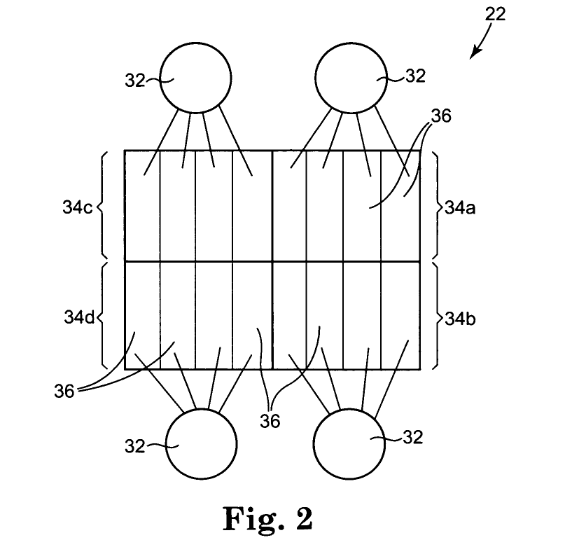

FIG. 2 schematically shows how megasonic energy source 22 might include four power supplies 32 that are used to drive four sub-arrays 34a, 34b, 34c, and 34d of crystals 36. Each crystal 36 (itself a resonating element) then drives the resonating elements, e.g., support plate, coupling water and quartz window, etc. to which the megasonic energy source 22 is acoustically coupled.

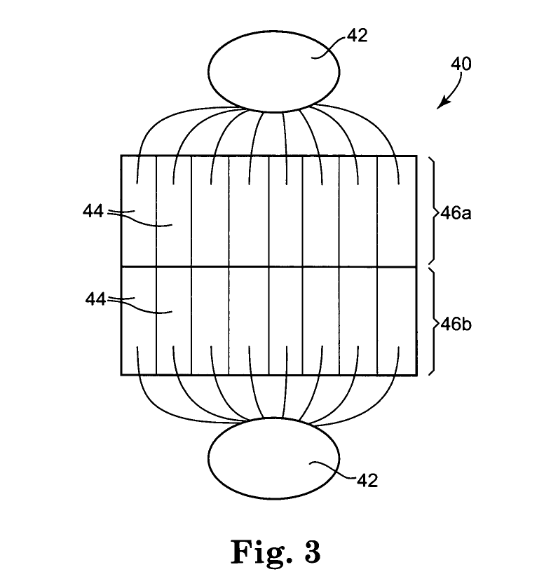

FIG. 3 schematically illustrates an alternative embodiment of a megasonic energy source 40 in which two, more powerful power supplies 42 can be used to drive the same number of crystals 44 arranged in two sub-arrays 46a and 46b wherein each sub-array 46a and 46b respectively includes eight crystals 44 and associated resonating elements.

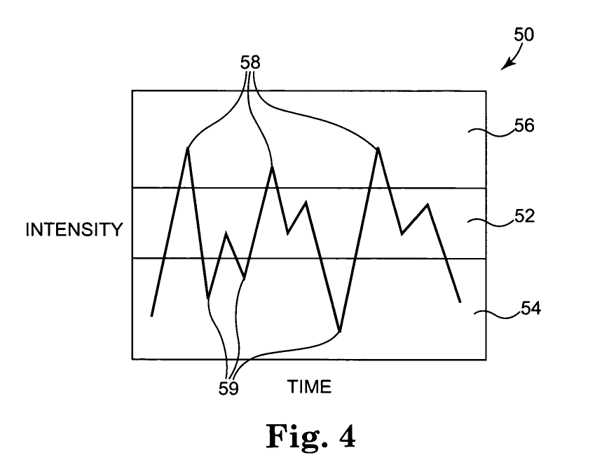

The present invention appreciates that the megasonic field established in the processing liquid 18 resulting from using megasonic energy source 22 in a conventional manner tends to be nonuniform both spatially and temporally. On a tank-wide basis, some areas of processing liquid 18 may tend to experience higher average megasonic field energy over time than other areas. FIG. 4 schematically shows a plot 50 of field intensity in process liquid 18 varying as a function of time at a localized region in a processing tank according to conventional practices. FIG. 4 shows the desired field intensities associated with a desired cleaning regime 52, a non-cleaning regime 54 in which field intensity is too low, and a damage regime 56 in which field intensity is too high. The megasonic field of FIG. 4 may vary in time due to one or more factors including constructive and destructive interference effects attributable to the manner in which the various sub-arrays of megasonic energy source 22 output sound energy to process liquid 18. In various areas, interference effects among the fields attributable to different sub-arrays may cause the megasonic energy field established in process liquid 18 to fall or rise outside of the desired cleaning regime 52. This can be problematic.

For example, if the megasonic energy is too high, as may occur at field maxima 58 associated with constructive interference, device features can be damaged. If too low, as may occur at minima 59 associated with destructive interference, poor process performance may result.

With such interference effects in mind, in some embodiments it is desirable to generate megasonic fields in a process liquid that are more spatially and temporally uniform both throughout process liquid 18 and at localized regions within process liquid 18 by minimizing such interference effects and other sources of field nonuniformities.

The present invention appreciates that there are multiple sources of field nonuniformity that can lead to undesired spatial and temporal nonuniformities of the sonified process liquid. Representative sources of nonuniformity include equipment features, how crystals are grouped with respect to being driven by one or more power sources, gaps in the arrangement of the piezoelectric crystals, reflections, imperfections in the individual crystals, or the like.

For instance, variations in thickness or acoustic properties of any of the components of a resonant structure can cause a variation in the “resonate frequency” of maximum transmission across the structure. Areas of high transmission will contribute to high-intensity regions in the processing liquid where damage is most likely to occur. Areas of low transmission contribute to low-intensity regions where process performance may be impaired. As the resonate structure has a very high “Q”, small variations in resonate frequency would translate to large variations in delivered acoustic intensity.

Grouping of crystals into sub-arrays can lead to nonuniformity, such as when multiple power sources are used to drive multiple crystal sub-arrays. For instance, large baths typically have multiple generators that operate at slightly different frequencies, each tuned to the average resonance frequency of their part of the resonate structure. The result is usually a field output not coordinated for the different sub-arrays. A result of having multiple frequencies in the sound field of a processing tank is that the field can be time varying in intensity in localized regions due to factors such as constructive and destructive interference of the waves. When the driving frequencies for each sub-array are not coordinated, each sub-array will tend to generate a field output that constructively and destructively interferes with the output of other sub-arrays. In general, such phase non-uniformity may tend to be more severe in areas influenced by more than one sub-array, such as in tank locations overlying a sub-array boundary or the like.

Practically, the temporal and spatial variation of field intensity causes “beats” in the process liquid's sound field. These beats may result in the sonic intensity varying from as little as zero to as much as four times the average. This can cause non-uniform processing, such as cleaning, for wafer(s) in the tank. Some portions of wafers can experience too little cleaning on average and at the other extreme some portions of wafers may be damaged due to high intensity sound waves. Consequently, reducing and/or eliminating the magnitude of these beats can help reduce damage that may occur during the high-intensity portion of the beat as well as lead to better cleaning performance during the low-intensity portion of the beat.

Accordingly, one embodiment of the present invention involves synchronizing the field output among sub-arrays of megasonic energy source 22, particularly when different power generators drive such sub-arrays. An experiment was performed to test the benefits of synchronizing the output of the different sub-arrays. The experiment was conducted in an FSI MAGELLAN® Alpha tank coupled to a megasonic energy source commercially available from Kaijo, Corporation of Japan. The Kaijo megasonic energy source included 4 sub-arrays driven by 4 separate generators, each tuned to its own frequency. Each sub-array included 4 crystals. This megasonic energy source was arranged similarly to megasonic energy source 22 shown in FIG. 2. Interference effects associated with the boundary between two of the sub-arrays were studied. When the two sub-arrays are driven at 300 W by separate, non-synchronized power sources, a stripe of non-cleaning was be observed in tank areas associated with the boundary between the sub-arrays. When both sub-arrays were hooked up to a single, 600 W power source, such that the sub-arrays were driven at the same frequency, the stripe of non-cleaning was dramatically reduced. This shows how coordinating the output of different sub-arrays reduces interference effects and improves cleaning performance. The same benefit would be observed by coordinating the two 300 W power sources instead of using a single 600 W power source.

An additional experiment was conducted with this same equipment to evaluate megasonic field output uniformity with unsynchronized generators. A beating of the sound energy waveform in the FSI MAGELLAN® Alpha tank was observed using a hydrophone to monitor sound wave intensity when the power generators were not synchronized. This beating occurred primarily in an area above boundaries between megasonic sub-arrays. This beating was observed to cause a reduction in cleaning efficiency with respect to the cleaning pattern on a 300 mm wafer in slot 13 that spans sub-arrays corresponding to 34a and 34c in FIG. 2. It was subsequently observed that the interference can be reduced or eliminated, and the cleaning efficiency correspondingly improved, by driving both sub-arrays from a common generator or synchronized generators.

As an alternative to a single common generator or synchronized generators, the interference can be eliminated in modes of practicing the present invention by exciting the individual sub-arrays sequentially and/or in partially overlapping fashion so that interference is eliminated during at least a portion of the processing. Experiments using the MAGELLAN® Alpha tank were conducted to evaluate the benefits of doing this. Cleaning performance was evaluated with respect to a wafer that was positioned over two underlying subarrays of the megasonic energy source. One sub-array was generally under the “left” side of the wafer, while the other sub-array was generally under the “right” side of the wafer. When only the left sub-array was excited during cleaning, cleaning was generally effective on the left side of the wafer while relatively less cleaning occurred on the right side of the wafer. Likewise, when only the right sub-array was excited during cleaning, cleaning was generally effective on the right side of the wafer while relatively less cleaning occurred on the left side of the wafer. It was observed that each sub-array cleans slightly more than about half of the wafer when the other sub-array was off. In another experiment, when both sub-arrays were excited throughout cleaning, interference effects as described above were observed. In another experiment, cleaning efficiency data was obtained from a process that involved alternating between 30 seconds of right array-and 30 seconds of left array during the course of the treatment. The data showed that the entire wafer was cleaned more effectively if the interfering sound fields were not present simultaneously during the entire processing time. This in turn shows that, generally, the interference among co-excited sub-arrays disrupts the cleaning and that reducing such interference improves performance. In sum, one mode of practicing the present invention involves exciting individual sub-arrays in sequential and/or partially overlapping fashion. As one benefit, this would minimize the adverse impact that sound interference might have upon process performance.

During the course of alternating excitation of sub-arrays according to this mode of practice, it may be convenient to pulse the sub-arrays for a shorter period of time, perhaps 1 second on/1 second off, or 1 msec on/off, etc. (With 4 arrays, perhaps 1 second on, 3 seconds off, for example, as the arrays are pulsed on in series fashion). Cycling the arrays on a time scale of seconds can be done in a variety of ways, e.g., with an RS-232 based automation control scheme or the like.

There are other undesired sources of nonuniformity associated with megasonic crystal arrays. In particular, each individual crystal (and its associated resonant elements) tends to have its own resonant frequency that may differ to some degree from other crystals in the same or other sub-arrays. In other words, the resonant frequencies of the individual elements across the entire resonant structure are typically not exactly equal. Indeed, the resonant frequency can differ within an individual crystal. Thus, individual crystals can resonate differently when driven at a single frequency, emitting differing levels of acoustic energy into the processing liquid. The field output still may not be as uniform as might be desired as a consequence. The magnitude of this kind of field variation is large enough to cause cleaning nonuniformities. In short, the individuality of crystal resonating characteristics can be a source of field nonuniformity, and hence cleaning nonuniformity.

Preferred modes of practicing the invention use frequency sweeping when driving megasonic crystals to reduce field nonuniformity attributable to such crystal resonating differences on a time-averaged basis. Optionally, frequency sweeping may be used in combination with synchronizing the excitation of different crystal sub-arrays and/or exciting sub-arrays in a manner so that at least one sub-array is off during at least a portion of the time that one or more other sub-array(s) are on.

Frequency sweeping generally refers to varying the frequency at which crystals are excited over a desired frequency range. Frequency sweeping is a very facile way to render field output more uniform on a time-averaged basis. As the driving frequency is swept, the individual crystals will each be subject to a particular driving frequency, preferably cyclically, in which they are more acoustically emissive than at other times during the sweep. The net effect can be a significant smoothing of the time-averaged spatial power distribution in the processing tank. The time averaged field strength throughout the volume of a tank would be more uniform while, at the same time, the time averaged field strength on a localized basis would also be more uniform with less extreme maxima and minima. Cleaning performance would be more consistent and the potential for acoustic field energy maxima to damage devices would be reduced.

In the practice of the present invention, acoustic field nonuniformities, especially those associated with crystal individuality, are substantially reduced on a time averaged basis using a frequency sweeping approach that varies, preferably cyclically, the frequency at which the crystals are driven. In other words, it has been discovered that by sweeping (dithering, modulating) the driving frequency, of a transducer across a frequency range with time (either one direction, back and forth, etc.), the output of a crystal or transducer array can be more uniform on average over time.

The range over which the driving frequency is swept generally is large enough to improve the time averaged field output to a desired degree. All or only a portion of the resonant frequencies of the individual crystals may be encompassed by a sweep.

For example, a megasonic system that includes crystals that individually resonate at frequencies in the range of 965 kHz to 975 kHz, would require a 10 kHz sweeping range to encompass the resonant frequencies of all the crystals. Of course, this particular range is provided for illustration. In actual practice, the desired upper and lower frequencies may be determined empirically.

A driving frequency sweep encompassing all or only a portion of this range may be used to improve the uniformity of the field output. Depending upon the sweep range, the lower resonant frequencies, the mid range resonant frequencies, and/or the higher range resonant frequencies may be swept. Preferably, at least 10%, more preferably at least 50%, more preferably at least substantially all of the resonant frequencies are swept.

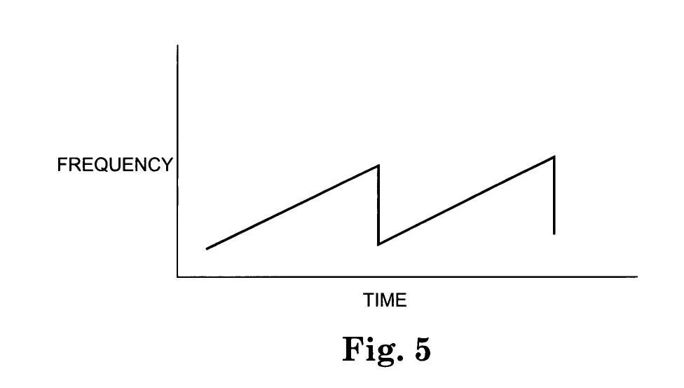

Any kind of driving frequency pattern may be used to vary the driving frequency. A preferred driving frequency profile is a saw tooth pattern such as shown in FIG. 5. With a saw tooth profile, excitation of each crystal having a resonant frequency in the sweep range will tend to occur at evenly spaced intervals once per sweep cycle. Otherwise, in the absence of a sweep, crystals driven near resonance will tend to be more emissive than others over time, leading to a nonuniform field in the process liquid.

The rate of change of the driving frequency during a sweep can vary over a wide range. As guidelines, a sweep changing frequency at a rate in a range from about 0.1 kHz/sec to about 100 kHz/sec, preferably 0.5 kHz/sec to 10 kHz/sec would be suitable. The rate of change of the frequency in the illustrated saw tooth pattern is linear, but this need not be the case. Any suitable profile can be used including those that are exponential, geometric, logarithmic, etc.

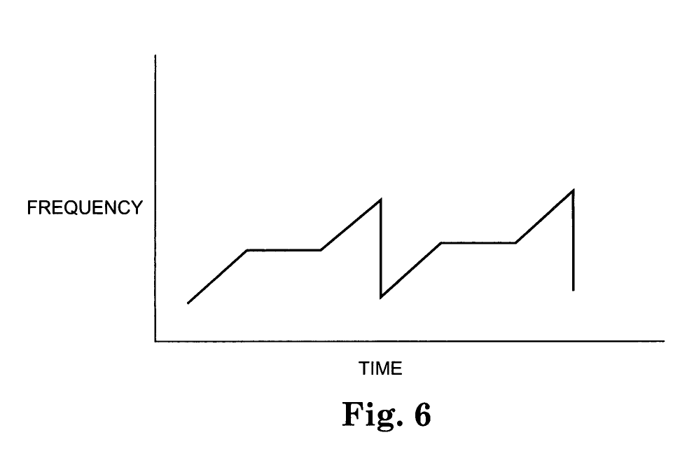

It is possible to coordinate the driving frequency profile with the individual crystal characteristics so as to drive some crystals at their resonant frequencies for longer or shorter durations than others. For example, if the crystals resonating in the mid range were known to be more inefficient, the driving frequency could spend more time in the mid range as shown by the exemplary driving frequency pattern of FIG. 6.

The equipment that may be used for frequency sweeping is very simple. In one embodiment, one or more signal generators provide signal(s) of the desired profile to a megasonic array, preferably through a power amplifier. The megasonic array has an acoustic output that can be modulated by a voltage input signal. Under certain conditions, the drive electronics of a power supply may need to be more robust to tolerate the variation in VSWR (Voltage Standing Wave Ratio) during the sweeping.

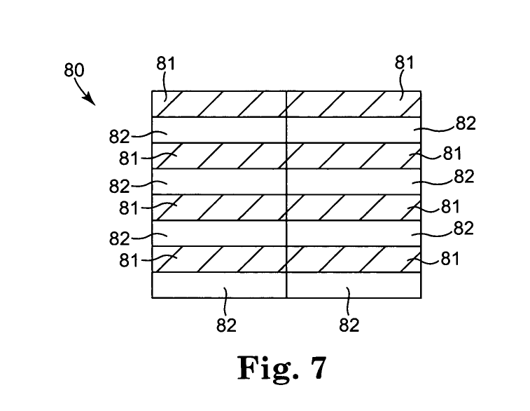

Multiple megasonic sub-arrays with multiple frequencies can be operated simultaneously if the sound field from one sub-array does not unduly affect the sound field from another array in the volume where the wafers reside. For example, FIG. 7 shows how sub-arrays 81 of an array 80 could be excited together as a group in alternating or partially overlapping fashion with sub-arrays 82 excited together as a group (two total generators). Of course, FIG. 7 shows only one possible grouping of sub-arrays. In other modes of practice, the sub-arrays could be arranged into groups for alternating or partially overlapping excitation in any desired combination.

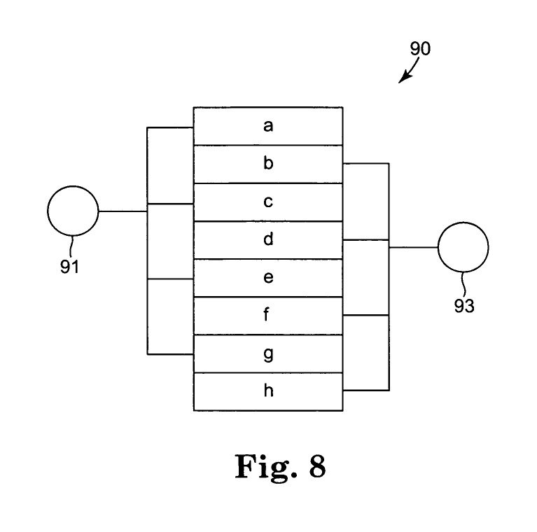

Group excitation of sub-arrays may be more desirable when there is a smaller number of individual crystals in each sub-array. The smaller the number of individual crystals in a group, the closer it is possible to match to the exact resonate frequency of the group. For instance, FIG. 8 shows an array 90 of crystals paired into 8 groups (small sub-arrays) a through h. With 2 generators 91 and 93, groups a, c, e, and g could be excited simultaneously at a common frequency followed by exciting b, d, f, and h simultaneously at a common frequency.

The above-described embodiments of the invention concern modes of practice in which it is desired to sonify a process liquid more uniformly both spatially and temporally. However, the present invention also appreciates that purposely modulating the sound field intensity over time in all or one or more portions of a processing tank may be beneficial when treating immersed wafers. In other words, it may be desirable to establish a sound field that modulates between maxima and minima, e.g., pulses on and off, on purpose. Temporal sound field modulation is particularly useful in particle cleaning applications to enhance particle removal efficiency and/or to allow use of an intermittent but relatively strong field that might otherwise damage wafer features if operated at a 100% duty cycle.

Generally, temporal sound intensity modulation occurs by modulating the intensity of sound energy emitted from an acoustic energy source that is acoustically coupled to the vessel in which an immersion treatment takes place. Such modulation generally involves causing the sound energy output of the acoustic energy source to vary according to a desired profile in which the output intensity ranges between one or more intensity maxima and one or more intensity minima. Preferably, the modulation occurs by pulsing the sound energy output on and off according to a desired duty cycle.

Such modulation may occur in any suitable fashion such as by directly modulating the sound energy source and/or controllably altering the acoustic coupling pathway between the sound energy source and the bath. Preferably, modulation occurs by modulating the output of the sound energy source, such as by pulsing one or more sub-arrays of the sound energy source on and off. When a sound energy source includes multiple arrays of crystals, all or a portion of the arrays may be modulated independently or together. In some embodiments, e.g., the so-called “sweet spot” embodiment described further below, it is preferred to modulate all of the arrays together in synchronized fashion.

Modulating the sound field intensity over time, e.g., by pulsing sub-arrays on and off, may be desirable for a number of reasons. First, pulsing can help reduce megasonic-induced damage that might otherwise occur if the sound field was to be on all the time. This also could allow more intense sound energy to be used during those portion(s) of the treatment during which sound energy is relatively high. In defiance of conventional wisdom, and as discussed further below, modulating the sound field intensity between relative maximum(s) and relative minimum(s) at an appropriate duty cycle and repetition rate provides improved particle removal efficiency. This improvement in particle removal efficiency is surprising because one would not expect more work (i.e., greater particle removal efficiency) to be accomplished when the sound energy is working less (i.e., less in the sense that the sound energy is used to sonify the process liquid only during a portion of a duty cycle).

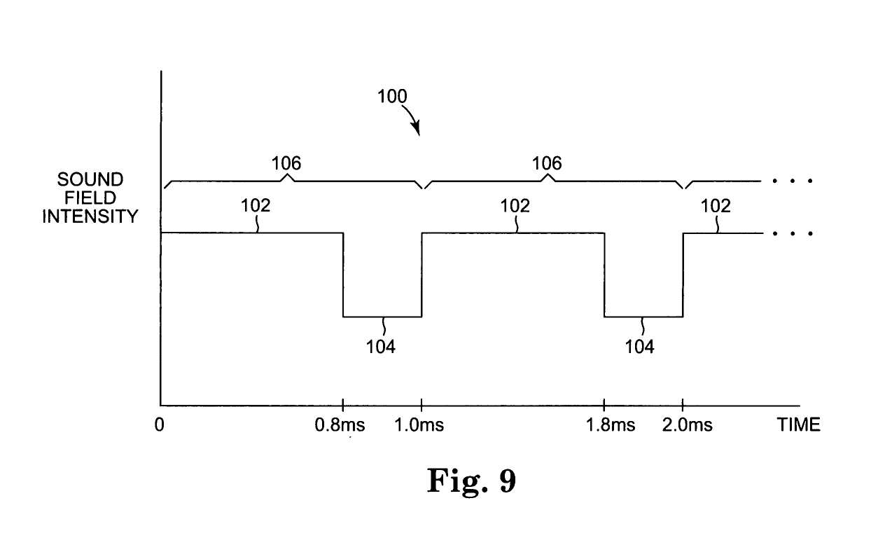

Such modulation may be practiced so that the duty cycle is repeating, random, patterned, or the like. For instance, FIG. 9 shows an illustrative repeating duty cycle pattern 100 in which the sound energy output of an acoustic energy source is pulsed between a field maximum portion 102 and minimum portion 104 (for instance, here the field is pulsed on and off) once per duty cycle 106. The duty cycle pattern 100 is uniquely characterized by the relative amounts that the sound field is on and off as well as the period (the period is also conveniently represented in terms its repetition rate, e.g., in cycles per second) of each duty cycle. For purposes of illustration, the duty cycle has a period of 1 millisecond. Typical embodiments may involve repeating the duty cycle in a regular fashion at repetition rates of from about 0.1 Hz to 100,000 Hz in the course of treatments lasting from several seconds to several minutes.

For purposes of the present invention, the duty cycle may be expressed as a percentage that refers to that portion of each duty cycle during which the sound field is at relative maximum(s). In actual practice, the duty cycle percentage may vary over a wide range as desired. Suitable embodiments would involve practicing duty cycles in the range of from about 50% to about 99.9%, more preferably at least about 90% to about 99.9%. For purposes of illustration, the duty cycle shown in FIG. 9 is 80% in that the sound field is on for 80% of the duty cycle and off for 20% of the duty cycle.

The sound field may be propagated at one or more acoustic frequencies during the course of one or more duty cycles. In some embodiments, a single acoustic frequency is used. In other embodiments, the acoustic frequency may be swept through a range of frequencies during the course of a duty cycle. Such acoustic sweeping is described further above.

Wafers are typically immersed in a liquid bath during an acoustic treatment. The bath liquid typically is flowing during at least a portion of the treatment. In accordance with conventional practices, acoustic treatments, especially particle removal treatments, appear to be more effective when dissolved gas is present in the bath liquid. A wide variety of dissolved gases may be used. Examples include nitrogen, carbon dioxide, oxygen, ozone, helium, argon, combinations of these, and the like. Some dissolved liquids would also have a substantial vapor pressure and could act similarly to a dissolved gas. Examples include organic compounds (e.g., isopropyl alcohol), halogenated organic compounds, combinations of these, and the like. Nitrogen is preferred. The amount of dissolved gas in the process liquid may vary over a wide range. Typically, the gas may be present at a concentration of from about 1% to 100% of the saturation amount, preferably about 20% to 100% of the saturation amount. In one mode of practice, for example, using a bath liquid containing about 10.5 ppm nitrogen on a weight basis (about half the saturation amount) was found to be suitable. In other modes of practice, it may be desirable to dissolve gas in the liquid at an elevated pressure before dispensing the liquid into the bath so that the concentration of dissolved gas in the bath, at least before outgassing occurs, is supersaturated with respect to the gas solute.

According to conventional wisdom, one might expect an acoustic wafer treatment to provide a particle removal efficiency that roughly correlates to the duty cycle percentage of the acoustic energy. That is, one might expect less cleaning to occur with a lesser duty cycle percentage and more cleaning to occur with a greater duty cycle percentage. This correlation has in fact been observed in many modes of practice. In one experiment, for instance, carrying out cleaning at 50% duty cycle provided particle removal efficiencies that were roughly 50% of the particle removal efficiency provided by a 100% duty cycle.

Likewise, if the repetition rate of a particular duty cycle is fast enough, the acoustic energy might appear to be always on as a practical matter from the perspective of wafer(s) being treated. This kind of correlation, too, has been observed. In one experiment, carrying out an acoustic treatment at a duty cycle of 99.8% duty cycle at a repetition rate of 99.8 Hz provide particle removal efficiency that was about the same as carrying out an otherwise identical treatment carried out at a 100% duty cycle.

Surprisingly, though, it has been discovered that reducing the duty cycle does not always lead to lesser cleaning. In some instances, more cleaning occurs. Specifically, it has been found that carrying out acoustic treatments with certain duty cycle and/or repetition rate characteristics leads to significantly enhanced particle removal efficiency as compared to an otherwise identical treatment carried out at a 100% duty cycle. The duty cycle in such modes of practice might be reduced from 100%, yet more particles are being removed. For example, in one so-called “sweet spot”, we have observed that carrying out an acoustic treatment at a repetition rate of 10,000 Hz at a 99.8% duty cycle (time ratio of on:off is 10,000:100) yielded more than a 10% improvement in particle removal efficiency as compared to use of a 100% duty cycle. Another such “sweet spot” was observed when using a repetition rate of 999.9 Hz at a 99.8% duty cycle (relatively, the duty cycle involves 10,000 clock ticks at a maximum, e.g., on, and 100 clock ticks at a minimum, e.g., off).

As a consequence, preferred modes of practicing sound modulation during the course of wafer treatments, particularly particle removal treatments, involves determining duty cycle and/or repetition rate conditions that provide such sweet spots, i.e., conditions under which using a duty cycle less than 100% and/or repetition rate provides better performance with respect to a desired result, e.g., particle removal efficiency, than an otherwise identical treatment carried out at a duty cycle of 100%.

To find such sweet spot conditions, design experiments in which duty cycle and/or repetition rate are varied may be performed. According to an illustrative design experiment for determining one or more sweet spots for particle removal, test wafers are contaminated with particles. The contaminated wafers are then subjected to particle removal treatments in which particle removal efficiencies at various duty cycles and repetition rates are determined. These results may then be used to select conditions, particularly sweet spot conditions, for using acoustic treatments to clean particles from wafers.

Other preferred modes of practicing sound modulation during the course of wafer treatments, particularly particle removal treatments, involves carrying out wafer treatments under duty cycle and/or repetition rate conditions that provide such sweet spots. Examples of such treatments involve immersing one or more wafers in a sonified bath, which may be flowing, while the acoustic energy used to sonify the bath is modulated at a repetition rate in the range of 500 Hz to 20,000 Hz, preferably 800 Hz to 15,000 Hz, more preferably 800 Hz to 12,000 Hz at a duty cycle in the range of 10% to 99.99%, preferably 80% to 99.9%, more preferably 90% to 99.9%.

While not wishing to be bound by theory, a possible rationale to explain the advantages observed at duty cycle and repetition rates providing sweet spots may be suggested. Particle removal maps of test wafers have shown that modulating the sound energy used to sonify immersed wafers under conditions providing a sweet spot tends to remove particles to a greater degree over more surface areas of the wafers. The boost in particle removal efficiency is believed to result from the greater degree of particle removal occurring in these additional areas.

Acoustic treatment of wafers in which the intensity of the sonic energy is modulated, e.g., pulsed on and off in preferred embodiments, between intensity maxima and minima may be practiced in a wide variety of equipment. Preferably, the equipment includes an immersion tank in which the wafers can be fully immersed in a suitable liquid during sonification. Specific examples of suitable wet bench equipment having megasonic capability include the MAGELLAN® tool commercially available from FSI International, Inc., Chaska, Minn.; the FC-3000 and FC03010 tools available from Dainippon Screen Mfg., Co. Ltd., the UW200Z and UW300Z tools available from Tokyo Electron Limited; and the ECLIPSE 300, AWP300, and AWP 200 tools available from SCP Global Technologies, Inc. The present invention may also be practiced in single wafer immersion tools such as the EMERSION 300 available from SCP Global Technologies.

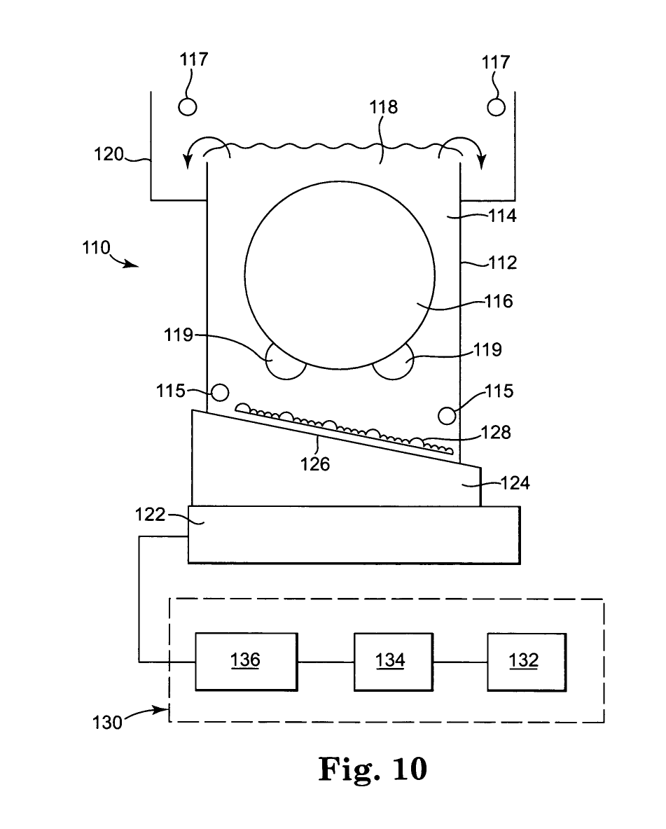

FIG. 10 shows another embodiment of a tank 110 having acoustic capabilities and being useful in practicing pulsing modes of the present invention. Tank 110 may be used to treat wafers either singly or in batches. For higher throughput, batch processing is preferred. Tank 110 generally includes a housing 112 defining a process chamber 114 in which one or more wafers 116 are immersed in a cascading flow of process liquid 118. Liquid 118 may be introduced into process chamber 114 through one or more entry ports such as sparger bars 115 located generally toward the bottom of process chamber 114 and/or spray bars 117 at the top of tank 110. Sparger bars 115 are conveniently used to fill and/or rinse tank 110, while spray bars 117 are conveniently used to rinse tank 110. Liquid 118 exits process chamber 114 by cascadingly overflowing into overflow weir 120 generally at the top of process chamber 114. Liquid 118 may also exit process chamber 114 through quick dump valves 119. Housing 112 and overflow weir 120 are conveniently manufactured from an acoustically transmissive material such as quartz and/or a chemically inert polymer, including one or more fluoropolymers such as polyvinylidene fluoride (often referred to as PVDF).

Acoustic energy source 122 provides sound energy to the processing liquid 118. In this example, the acoustic energy source 122 is external to the process chamber 114. The acoustic energy source 122 is acoustically coupled to the contents inside the processing chamber 114 by a coupling fluid 124 such as water or the like. A quartz window 126 provides a pathway for acoustic energy to pass from the coupling fluid 124 into the process chamber 114. The tilting of quartz window 126 helps liquid to drain and reduces bubble formation. An acoustic lens 128 of the type shown in FIGS. 13 and 14 of Assignee's Co-pending Non-Provisional Application is positioned between the quartz window 126 and the wafer(s) 116. The area of the lens elements of acoustic lens 128 is larger than the footprint of wafer(s) 116 overlying the acoustic lens 128. Pulsing of the megasonic energy is controlled by control system 130, which includes a signal generator 132, power amplifier 134, and matching network 136.

The present invention will now be further described in connection with the following examples. One exemplary process recipe for cleaning immersed wafers using a MAGELLAN tool fitted with the immersion tank 110 of FIG. 10 is described in the examples.

### EXAMPLE 1

### Si₃N₄ Slurry Contamination

A Si₃N₄ stock slurry was prepared by adding 40 mg of Alfa Aesar silicon (IV) nitride, electronic grade, to 100 ml of DI water. This was ultrasonicated for 5 minutes. Then 40 microliters of the slurry was pipetted into the 50 liter tank of a Yield Up Model 2000 tool as the bath was filling with DI water at about 20° C. Additionally, aqueous HCl (50 ml of concentrated HCl dissolved in 4 liters of DI water) was added to lower the pH of the bath to below about 2 as the tank was being filled. The flow of DI water was stopped before overflow began. 200 mm or 300 mm wafers were immersed in the Si₃N₄-containing bath, rinsed with DI water, and then dried. The Si₃N₄ particles were aged on the wafers for about 24 hours before use.

### EXAMPLE 2

### Wafer Cleaning and Assessment of Particle Removal Efficiency

Wafer cleaning and drying of contaminated wafers was carried out in a MAGELLAN® Alpha tool commercially available from FSI International, Inc., Chaska Minn. Cleaning and rinsing occurred in a megasonic immersion tank of the tool modified in accordance with FIG. 10. Drying occurred in a separate tank of the tool using the standard STG™ drying recipe. Several batches of wafers were processed to assess the impact of duty cycle and repetition rate upon particle removal efficiency.

For each test batch, the megasonic immersion tank was filled with a cascading flow of 1:1:200 SC-1 solution at 40° C. This solution included 1 part by weight of 29% aqueous ammonium hydroxide, 1 part by weight of 30% aqueous hydrogen peroxide, and 200 parts by weight of DI water. The DI water included about 10.5 ppm (on a weight basis) dissolved N₂. The solution flowed at 20 lpm. Megasonic energy was used to sonify the bath. The megasonic energy source was a megasonic plate and generator obtained from Kaijo. This had about a 360 W forward power at 971 kHz. Initially, megasonics were off. A carrier including 1 test wafer in slot 12 and 8 dummy wafers positioned in slots 8-11 and 13-16 was immersed in the cascading bath. Then, the megasonic energy was engaged according to the desired duty cycle and repetition rate to sonify the cascading bath and expose the contaminated wafers to the acoustic energy. Megasonic cleaning occurred for 6 minutes. After 6 minutes, the megasonic energy source was turned off and the flow of liquid was transitioned to a 20 second flow of room temperature DI water at 20 lpm. This was followed by a quick dump of the liquid contents of the vessel for about 30 seconds. Then, according to a first, follow up rinsing/dumping treatment, the vessel holding the wafers was filled with a cascading flow 40 lpm) of room temperature DI water. The filling and cascading occurred over a time of 120 seconds. Then, the liquid contents of the vessel were quick-dumped over a time period of 30 seconds. This rinsing/dumping treatment was repeated two more times. After the third rinsing/dumping treatment, the carrier holding the wafers was transferred to a different tank of the MAGELLAN® tool filled with room temperature DI water in which the wafers were dried using the standard STG™ drying recipe. The drying treatment according to the STG™ drying recipe involves slowly draining the water in the tank while exposing the wafers to a drying composition including nitrogen gas and IPA vapor that is prepared by bubbling the nitrogen gas through IPA liquid. The nitrogen gas was supplied at about 65° C., and the IPA liquid was at about 26° C. The STG™ drying recipe occurred over 9 minutes.

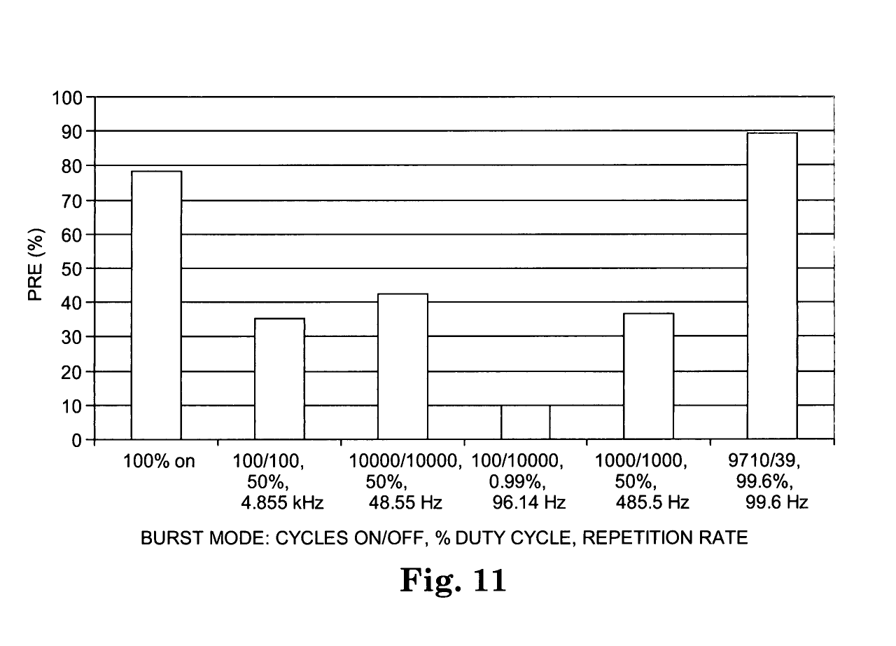

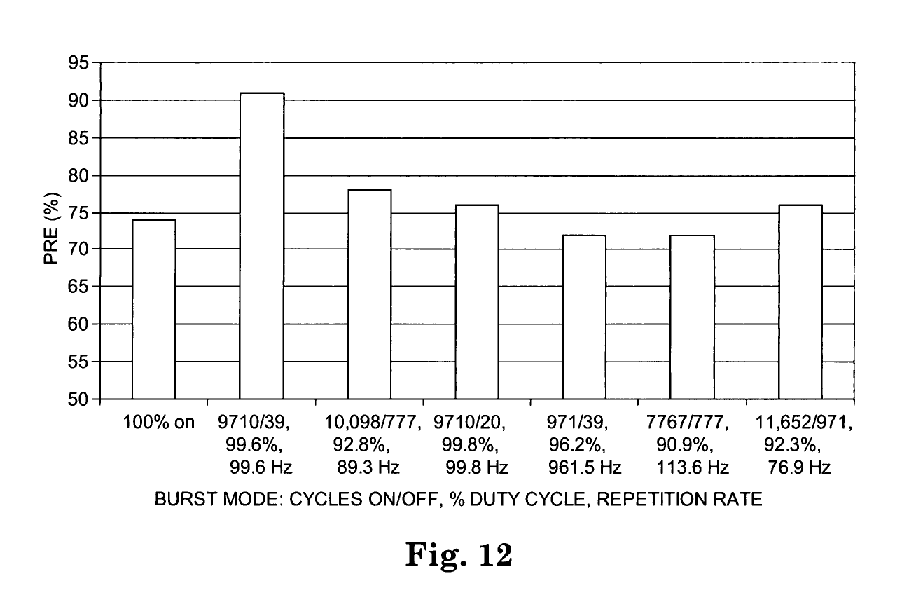

For each cleaned batch, the test wafer from slot 12 of the carrier was tested to assess particle removal efficiency (PRE). PRE was determined by performing three measurements of the particles on the wafer surface using a KLA Tencor Surfacan SP1-TBI instrument and then using the following formula:
[(N_{D}−N_{P})]/[(N_{D}−Nₒ)]×100%
wherein:
N_{D} is the number of Si₃N₄ particles after deposition;
N_{P} is the number of Si₃N₄ particles after processing; and
Nₒ is the number of particles before contamination.
   The results for each test condition as shown in FIGS. 11 and 12 represent an average of the three measurements.

The results are shown in FIGS. 11 and 12. The test results show that, generally, reducing the duty cycle of the megasonic energy used to sonify the cleaning bath leads to a commensurate reduction in cleaning efficiency. For instance, the cleaning that occurred with the megasonic energy source pulsed at a 50% duty cycle at 5 kHz and 500 Hz, respectively, yielded about half of the cleaning performance as the 100% duty cycle. However, certain “sweet spots” were observed in which the combination of a reduced duty cycle and a moderately fast repetition rate yielded cleaning performance even better than that observed with a 100% duty cycle.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

1. A method for processing one or more wafers in a sound field, the method comprising:
providing one or more wafers in a processing apparatus having a processing tank and a source of sound energy acoustically coupled to the processing tank; and
producing a sound field in the processing tank by inputting a non-constant driving signal to the source of sound energy.

2. The method of claim 1, wherein the driving signal has a cyclic saw-tooth profile.

3. A processing apparatus, the apparatus comprising:
a processing tank in which one or more wafers are positioned in a process fluid during a treatment; and
a modulatable sound energy source acoustically coupled to the processing tank.

4. The processing apparatus of claim 3, further comprising a source of a non-constant input signal modulatingly coupled to the modulatable sound energy source.

5. The processing apparatus of claim 4, wherein the modulatable sound energy source comprises two or more crystals and the input signal cyclically sweeps in a frequency range encompassing a resonant frequency of the two or more crystals.

6. A method of driving a sound energy source, the method comprising the steps of:
determining information indicative of a resonant characteristic of a sound energy source; and
using data comprising said information indicative of a resonant characteristic of a sound energy source to provide a non-constant driving signal as an input to modulate sound energy of the source.

7. The method of claim 6, wherein the non-constant driving signal comprises a driving signal that cyclically modulates the sound energy of the source.

8. The method of claim 6, wherein the non-constant driving signal comprises a driving signal that follows a saw-tooth profile to modulate the sound energy of the source.

9. A method of modulating a sound field, the method comprising the steps of:
determining information indicative of a nonuniformity of a sound field generated in a process fluid; and
using data comprising said information indicative of a nonuniformity of a sound field generated in a process fluid to modulate the sound field.

10. The method of claim 9, further comprising the step of cyclically modulating the sound field.

11. The method of claim 9, further comprising the step of sweeping the sound field in at least one frequency range.

12. The method of claim 9, further comprising the step of modulating the sound field by a saw-tooth profile.

13. A method for processing one or more wafers in a sound field, the method comprising:
providing one or more wafers that are immersed in a processing liquid, wherein the processing liquid is acoustically coupled to a source of sound energy; and
producing a sound field in the processing tank by inputting a non-constant driving signal to the source of sound energy, wherein the non-constant driving signal causes the source of sound energy to output sound energy whose intensity varies between one or more sound intensity maxima and one or more sound intensity minima.

14. A method for processing one or more wafers in a sound field, the method comprising:
providing one or more wafers that are immersed in a processing liquid, wherein the processing liquid is acoustically coupled to a source of sound energy; and
causing an acoustic output of the source of sound energy to vary between one or more sound intensity maxima and one or more sound intensity minima during at least a portion of carrying out a treatment of the one or more wafers.

15. A method for processing one or more wafers in a sound field, the method comprising:
providing one or more wafers that are immersed in a processing liquid, wherein the processing liquid is acoustically coupled to a source of sound energy; and
causing the source of sound energy to output sound energy at a duty cycle less than 100% during at least a portion of carrying out a treatment of the one or more wafers.

16. A method for processing one or more wafers in a sound field, the method comprising:
providing one or more wafers that are immersed in a processing liquid, wherein the processing liquid is acoustically coupled to a source of sound energy; and
causing the source of sound energy to pulse on and off during at least a portion of carrying out a treatment of the one or more wafers.
